(19) United States
(12) Patent Application Publication
(10) Pub. No.: US 2012/0176127 A1
(43) Pub. Date: Jul. 12, 2012

(54) APPARATUS FOR PIPELINE INSPECTION

(76) Inventors: Leon Joseph Fussell, Newcastle-upon-Tyne (GB); Raymond Paul Harvey, Newcastle-upon-Tyne (GB)

(21) Appl. No.: 13/347,510

(22) Filed: Jan. 10, 2012

(30) Foreign Application Priority Data
Jan. 10, 2011 (GB) 1100306.8

(51) Int. Cl. G01N 27/82

(52) U.S. Cl. 324/220

(57) ABSTRACT

A sensor assembly for pipeline inspection is provided. The sensor assembly comprises a sensor arm configured to mount the sensor assembly to a pipeline inspection tool and a sensor carrier configured to support a magnetic flux leakage sensor, the sensor carrier being pivotably coupled to the sensor arm by a pivot pin, wherein the sensor arm comprises a first end configured to connect the sensor assembly to a pipeline inspection tool, a distal end adjacent to which the sensor carrier is secured, and multiple elongate sections which cooperate with one another to capture the pivot pin at the distal end of the sensor arm and thereby secure the sensor carrier for movement with the sensor arm.

### BACKGROUND OF THE INVENTION

1. Field of the Invention

The disclosure relates to apparatus for pipeline inspection, more particularly, to apparatus for in-line inspection of a fluid pipeline, e.g. an oil or gas pipeline.

2. Description of Related Art

It is known to inspect the inside of a pipeline using an inspection apparatus commonly referred to as a pipeline “pig”. A known pig includes a magnetic arrangement configured to generate a magnetic field adjacent the inner wall of the pipe as the pig is driven along the pipe. The known pig further includes magnetic flux leakage (MFL) sensors, which are configured to detect changes in magnetic flux density of the magnetic field as the sensors travel along the pipe. This makes it possible to detect and analyse defects in the pipeline, such as corrosion, cracks or laminations in the pipe wall.

Typically, the MFL sensors are deployed on sensor arms which project in a radial array from the tool and are spring biased to urge the sensors into contact with an internal surface of a pipeline.

Conventional pipelines are constructed from individual sections of pipe, which are interconnected to define a string of pipe sections. Typically, the joint between adjacent pipe sections defines an internal projection in the pipeline, such as a bead formed by welding the two pipe sections together. However, weld beads and other internal projections present an inspection problem, since the sensor arm will often lose contact with the pipe wall when it strikes the projection. Moreover, the sensor arm may reverberate for a period of time after the strike. Hence, inspection data may be lost until such time as the sensor arm regains more permanent travel along the pipe wall.

Moreover, the impact of weld bead strikes can lead to wear or other damage to the sensors and sensor arms, which can inhibit the ability of the apparatus to record accurate data. Repair and maintenance of the apparatus can be costly, e.g. in terms of production costs and the period of time in which the tool is out of use.

The disclosure overcomes or mitigates the above-discussed problems, or other disadvantages or problems, associated with known inspection apparatus.

### BRIEF SUMMARY OF THE INVENTION

According to one embodiment of the present invention, a sensor assembly for pipeline inspection is provided. The sensor assembly comprises a sensor arm configured to mount the sensor assembly to a pipeline inspection tool and a sensor carrier configured to support a magnetic flux leakage sensor, the sensor carrier being pivotably coupled to the sensor arm by a pivot pin, wherein the sensor arm comprises a first end configured to connect the sensor assembly to a pipeline inspection tool, a distal end adjacent to which the sensor carrier is secured, and multiple elongate sections which cooperate with one another to capture the pivot pin at the distal end of the sensor arm and thereby secure the sensor carrier for movement with the sensor arm.

According to another embodiment of the present invention, a sensor assembly for pipeline inspection is provided. The sensor assembly comprises a sensor arm configured to mount the sensor assembly on a pipeline inspection tool; and a sensor carrier configured to support a magnetic flux leakage sensor, the sensor carrier being pivotably coupled to the sensor arm by a pivot pin, wherein the sensor arm comprises a first end configured to connect the sensor assembly to an inspection tool, a second end adjacent to which the sensor carrier is secured, and injection moulded or other plastic sections which cooperate with one another to capture the pivot pin and thereby secure the sensor carrier for movement with the sensor arm.

According to another embodiment of the present invention, a sensor carrier for a sensor assembly on a pipeline inspection apparatus is provided. The sensor carrier comprises a compartment having an open end through which a sensor may be inserted into the sensor carrier, and wherein the sensor is secured in place in the compartment by a resilient clip.

### BRIEF DESCRIPTION OF THE SEVERAL VIEWS OF THE DRAWINGS

The accompanying drawings, which are incorporated in and constitute a part of the specification, illustrate one or more embodiments and, together with the description, explain these embodiments. In the drawings:

FIG. 1 is a schematic side view of part of a pipeline inspection apparatus;

FIG. 2 is an exploded perspective view of a sensor arm, sensor carrier and sensor for use in the apparatus of FIG. 1;

FIG. 3 is an exploded perspective view of a sensor carrier and sensor for use in the apparatus of FIG. 1;

FIG. 4 is a schematic cross-sectional view through a sensor for use in the apparatus of FIG. 1;

FIG. 5 is a schematic perspective view of a sensor carrier for use in the apparatus of FIG. 1 in a first position; and

FIG. 6 is a schematic perspective view of a sensor carrier for use in the apparatus of FIG. 1 in a second position.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

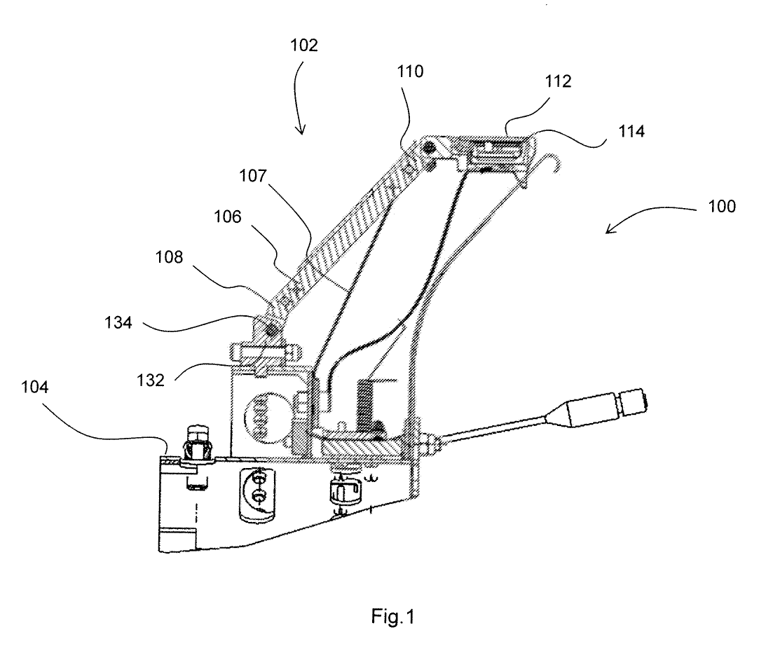

Referring firstly to FIG. 1, an apparatus for pipeline inspection is indicated generally at 100. The apparatus 100 includes a sensor assembly 102 mounted on an inspection tool or “pig” (only part of which is indicated at 104) configured for in-line inspection of pipelines. In general terms, the sensor assembly 102 is used to detect corrosion and other defects in the material of the pipeline along which the tool 104 is travelling.

The sensor assembly 102 consists of a plurality of sensor arms 106 (only one of which is shown in FIG. 1, for ease of illustration) which project in a radial array from the tool 104. Each sensor arm 106 has a first end 108 for connection to the tool 104 and a second end 110 remote from the tool 104. As such, the first end 108 may be referred to as the ‘fixed’ end, and the second end 110 may be referred to as the ‘distal’ end. A sensor carrier 112 is connected to the second end 110 of each arm 106 and a magnetic flux leakage (MFL) sensor 114 is supported in each sensor carrier 112.

The tool 104 includes a magnetic arrangement (not shown) for generating a magnetic field adjacent the inner wall of the pipe along which the tool 104 is travelling. The sensor arms 106 are spring biased (e.g. by spring 107), for urging the sensors 114 into contact with the inner wall.

The sensors 114 detect changes in the magnetic flux density, as the tool travels along the pipe. Data from the sensors 114 is recorded and analysed to detect defects in the pipeline, such as corrosion, cracks or laminations in the pipe wall.

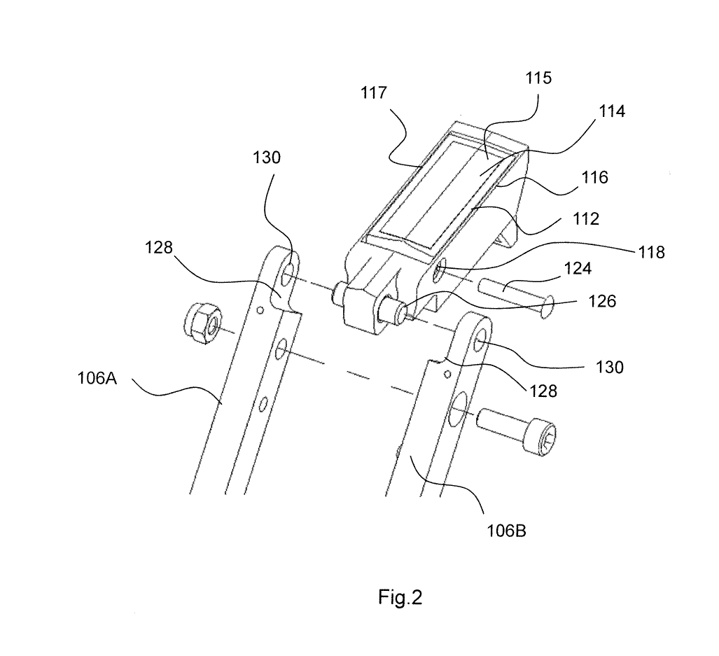

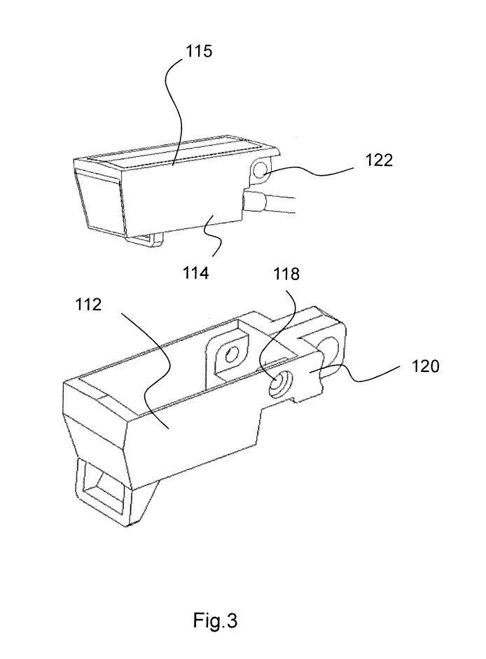

FIGS. 2 and 3 show an exemplary embodiment of a sensor arm 106, sensor carrier 112 and sensor 114 for use in the apparatus 100 of FIG. 1.

In this embodiment, the sensor carrier 112 defines a compartment 116 into which the sensor 114 is fitted. The sensor 114 has a sensor face 115 which is directed outwardly from an open end 117 of the compartment 116.

An aperture 118 is formed in a side 120 of the compartment 116. A correspondingly located aperture 122 is formed in the sensor 114. A locating pin 124 is used to extend through the aperture 118 in the compartment 116 and into the aperture 122 in the sensor 114, for securing the sensor 114 for travel with the sensor carrier 112.

The sensor carrier 112 includes a pivot pin 126, by means of which the carrier 112 can be pivotably connected to the sensor arm 106. In exemplary embodiments, the sensor carrier 112 is an injection moulded component (e.g. made from plastics material) and the pivot pin 126 may be over-moulded during the injection moulding process, so as to be integral with the sensor carrier 112 prior to connection to the sensor arm 106. This reduces the number of steps required to assemble the apparatus 100.

In this embodiment, the sensor arm 106 consists of multiple elongate sections 106A, 106B which cooperate with one another to capture the pivot pin 126, and thereby secure the sensor carrier 112 for movement with the sensor arm 106. The sensor arm 106 is split along its length between the first and second ends 108, 110 to define said elongate sections 106A, 106B. As can be seen, the pivot pin 126 extends in a first direction and the arm 106 is split along an axis which extends in a direction perpendicular to said first direction. In this embodiment, the sensor arm 106 is split into two halves (defined by the elongate sections 106A, 106B) along its length.

The elongate sections 106A, 106B each define a recess 128 at the second end 110 for capture of the pivot pin 126. The elongate sections 106A, 106B are secured together at the second end 110 using a nut and bolt arrangement, e.g. of stainless steel construction, passing through respective apertures 130 in the elongate sections 106A, 106B. A similar arrangement (not shown) is used to secure the elongate sections 106A, 106B together at the first end 108.

Referring back to FIG. 1, the first end 108 of the sensor arm 106 is pivotably coupled to a pivot block 132, by means of which the sensor arm is mounted on the tool 104. The sensor arm 106 is coupled to the pivot block 132 by a further pivot pin 134, in order to be pivotable relative to the tool 104 and to secure the sensor arm 106 for movement with the pivot block 132. The further pivot pin 134 extends in a first direction which is perpendicular to the axis along which the sensor arm is split into the elongate sections 106A, 106B.

Although not shown, it will be understood that the two elongate sections 106A, 106B of the sensor arm 106 cooperate to capture said further pivot pin 134. More particularly, the two elongate sections 106A, 106B each defines a recess for capture of said further pivot pin 134, e.g. in the same manner as described above (in relation to the pivot pin 126).

In exemplary embodiments, the pivot block 132 is an injection moulded component (e.g. made from plastics material) and the pivot pin 134 may be over-moulded during the injection moulding process, so as to be integral with the pivot block 132 prior to connection of the sensor arm 106. This reduces the number of steps required to assemble the apparatus 100.

In exemplary embodiments, the sensor arm is made from a lightweight material such as Nylon. Nylon 12 has been found to provide particular benefits, in terms of weight reduction and suitability for use in the harsh operating conditions of in-line inspection.

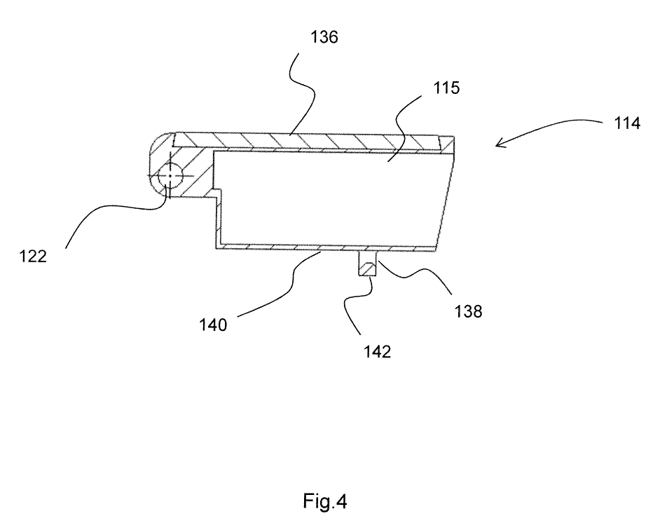

A known MFL sensor 114 is shown in FIG. 4. The sensor 114 has a sensor face 115 which is directed outwardly from an open end of the carrier 112 (e.g. as shown at 117 in FIG. 2), in use. The sensor face 115 is covered by a wear strip 136. The sensor 114 also includes an aperture 122 for receiving a locating pin, e.g. as described with respect to FIG. 2. The sensor 114 further includes a projection 138 on its underside 140 which defines an aperture 142 for receiving a securing device (as will be described below).

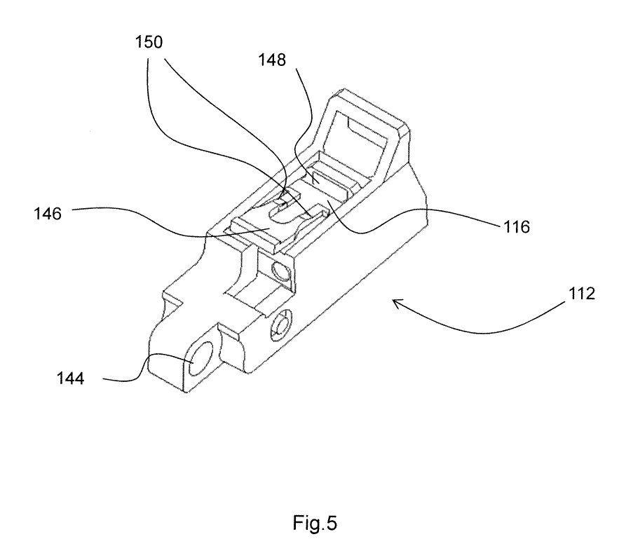

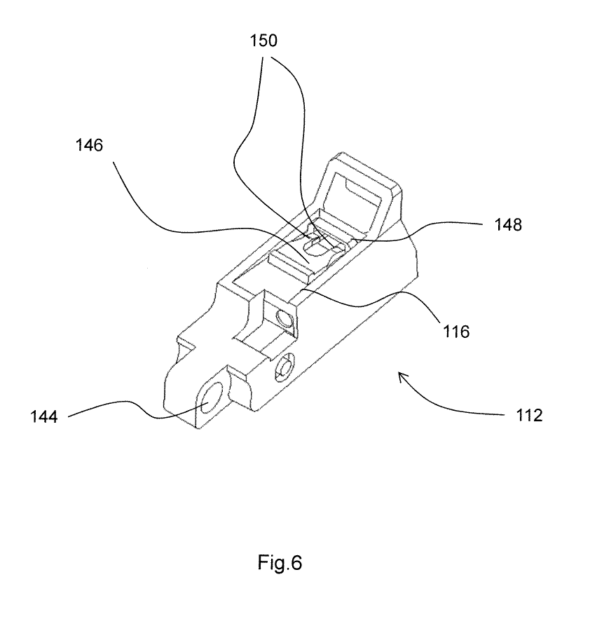

FIGS. 5 and 6 show an exemplary embodiment of a sensor carrier 112 configured for use with sensors 114 of the kind shown in FIG. 4. As described above, the sensor carrier 112 defines a compartment 116 into which the sensor 114 is fitted. The sensor 114 has a sensor face 115 which is directed outwardly from an open end 117 of the compartment 116. An aperture 118 is formed in a side 120 of the compartment 116 for receiving a locating pin, e.g. as described with respect to FIG. 2. The sensor carrier 112 defines an aperture 144 for a pivot pin 126, by means of which the carrier 112 can be pivotably connected to a sensor arm 106. The carrier 112 may be an injection moulded component and the pivot pin 126 may be over-moulded during the injection moulding process.

In this embodiment, the sensor 114 is secured in place in the compartment 116 by a resilient clip 146. The compartment 116 includes a window 148 which is positioned so that the aperture 142 on the sensor 114 is accessible through said window 148. As can be seen from FIGS. 5 and 6, the clip 146 can be inserted into the carrier 112 so as to extend through said window 148 and said aperture 142. The clip 146 includes two resilient arms 150, which adopt a snap-fitting engagement with the inside of the compartment 116 once inserted in the manner shown in FIG. 6, to bias the sensor 114 against movement within the compartment 116. The clip 146 can be easily connected and removed, yet is robust enough to survive the pipeline environment. It allows the MFL sensor 114 to be removed and re-used.

Tests indicate that the apparatus will exhibit improved dynamic performance and resistance to pipeline operating environments. The apparatus further provides reduced manufacturing costs and lead time, as well as ease of assembly and maintenance (e.g. when replacing damaged/worn components). The exemplary sensor carrier allows MFL sensors to be fitted and replaced with ease. Using an injection-moulding process reduces manufacturing costs and lead-time compared to conventional machined components. Nylon 12 offers great resistance to pipeline operating environments. Being lightweight it also reduces sag in support assemblies on the inspection tool, e.g. a conventional floating ring arrangement.

However, other production techniques and/or plastics materials may be used in alternative embodiments, e.g. die casting, rotational moulding or shell moulding.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended and are understood to be within the scope of the claims.

What is claimed is:

1. A sensor assembly for pipeline inspection, the sensor assembly comprising:
a sensor arm configured to mount the sensor assembly to a pipeline inspection tool; and
a sensor carrier configured to support a magnetic flux leakage sensor, the sensor carrier being pivotably coupled to the sensor arm by a pivot pin,
wherein the sensor arm comprises a first end configured to connect the sensor assembly to a pipeline inspection tool, a distal end adjacent to which the sensor carrier is secured, and multiple elongate sections which cooperate with one another to capture the pivot pin at the distal end of the sensor arm and thereby secure the sensor carrier for movement with the sensor arm.

2. The sensor assembly according to claim 1, wherein the sensor arm comprises a two-part body comprising two elongate sections which cooperate with one another to capture the pivot pin at the distal end of the sensor arm.

3. The sensor assembly according to claim 1, wherein the sensor arm comprises an elongate body, and wherein the elongate body is split into two halves along its length.

4. The sensor assembly according to claim 3, wherein the two halves of the body each comprise a recess at one end for capture of the pivot pin.

5. The sensor assembly according to claim 3, wherein the pivot pin extends in a first direction and the elongate body is split along an axis which extends in a direction perpendicular to the first direction.

6. The sensor assembly according to claim 1, wherein a pivot block is mounted at the first end of the sensor arm, the pivot block being configured to attach the sensor assembly to a pipeline inspection tool.

7. The sensor assembly according to claim 6, wherein the pivot block is coupled to the sensor arm by a further pivot pin, and the elongate sections of the sensor arm cooperate to capture the pivot pin at the distal end of the sensor arm, and thereby secure the sensor arm for movement with the pivot block.

8. The sensor assembly according to claim 7, wherein the sensor arm is split into two halves along its length, wherein each half comprises a recess for capture of the further pivot pin.

9. The sensor assembly according to claim 7, wherein the further pivot pin extends in a first direction and the sensor arm is split along an axis which extends in a direction perpendicular to the first direction.

10. The sensor assembly according to claim 1, wherein the sensor arm is made from a plastic material.

11. The sensor assembly according to claim 1, wherein the sensor carrier is of injection moulded construction and the pivot pin is an over-moulded component of the sensor carrier.

12. The sensor assembly according to claim 6, wherein the pivot block is of injection moulded construction and the further pivot pin is an over-moulded component of the pivot block.

13. The sensor assembly according to claim 1, wherein the sensor carrier comprises a compartment having an open end through which a magnetic flux leakage sensor may be inserted into the sensor carrier.

14. The sensor assembly according to claim 1, wherein the sensor carrier comprises a compartment having an open end, and a magnetic flux leakage sensor is mounted in the compartment, wherein the magnetic flux leakage sensor has a sensor face which faces outwardly through the open end of the compartment.

15. The sensor assembly according to claim 14, wherein the magnetic flux leakage sensor is secured in place in the compartment by a resilient clip.

16. The sensor assembly according to claim 15, wherein the compartment comprises a window and the magnetic flux leakage sensor comprises an aperture which is accessible through the window, wherein the resilient clip extends through the window and the aperture, to bias the magnetic flux leakage sensor against movement within the compartment.

17. A sensor assembly for pipeline inspection, the sensor assembly comprising:
a sensor arm configured to mount the sensor assembly on a pipeline inspection tool; and
a sensor carrier configured to support a magnetic flux leakage sensor, the sensor carrier being pivotably coupled to the sensor arm by a pivot pin,
wherein the sensor arm comprises a first end configured to connect the sensor assembly to an inspection tool, a second end adjacent to which the sensor carrier is secured, and injection moulded or other plastic sections which cooperate with one another to capture the pivot pin and thereby secure the sensor carrier for movement with the sensor arm.

18. A sensor carrier for a sensor assembly on a pipeline inspection apparatus, wherein the sensor carrier comprises a compartment having an open end through which a sensor may be inserted into the sensor carrier, and wherein the sensor is secured in place in the compartment by a resilient clip.

19. The sensor carrier according to claim 18 wherein the compartment comprises a window and the sensor comprises an aperture which is accessible through the window, wherein the resilient clip extends through the window and the aperture, to bias the sensor against movement within the compartment.

20. The sensor carrier according to claim 19 wherein the sensor carrier is of moulded or cast construction and comprises an integrally attached pivot pin for connecting the carrier to a sensor arm of a sensor assembly on a pipeline inspection apparatus.
